(19) United States
(12) Patent Application Publication
(10) Pub. No.: US 2009/0050431 A1
(43) Pub. Date: Feb. 26, 2009

(54) STARTING CLUTCH APPARATUS

(75) Inventors: Masaki Sakai, Fukuroi-shi (JP); Toshihiro Naruse, Fukuroi-shi (JP); Manabu Sawayanagi, Fukuroi-shi (JP); Tomoyuki Miyazaki, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/197,368

(22) Filed: Aug. 25, 2008

(30) Foreign Application Priority Data
Aug. 24, 2007 (JP) 2007-217935

(51) Int. Cl. F16D 13/74

(52) U.S. Cl. 192/70.12

(57) ABSTRACT

The present invention provides a starting clutch apparatus comprising a damper device connected to an output member of an engine, a wet type multi-plate clutch housed in a housing, a piston for pressing the wet type multi-plate clutch to tighten the clutch, and an output member connected to an input shaft of an automatic transmission and wherein an output of the engine is connected to or disconnected from the input shaft of the automatic transmission by engaging or disengaging the wet type multi-plate clutch, and further wherein the damper device includes a damper output portion engaged by an outer diameter portion of the housing.

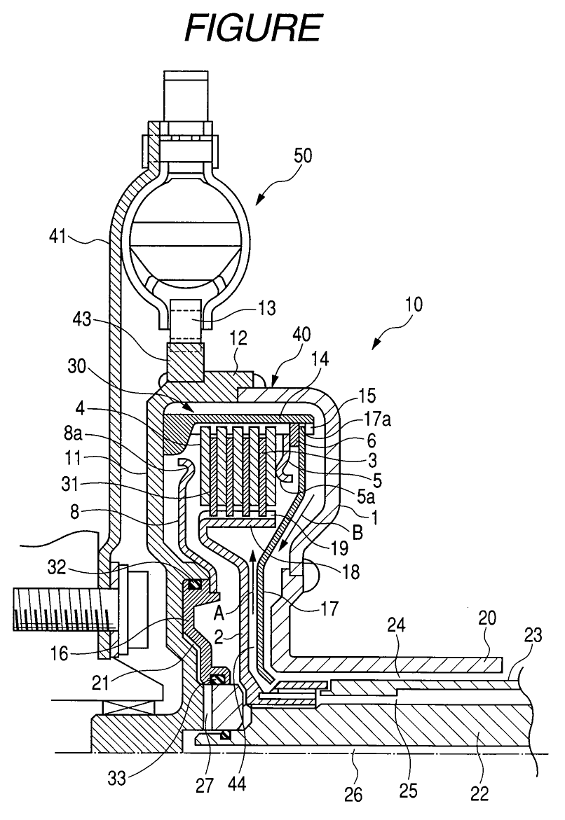

### BACKGROUND OF THE INVENTION

1. Field of the Invention

The present invention relates to a starting clutch apparatus used in motor vehicles and the like.

2. Related Background Art

Conventionally, in automatic transmissions, the starting of a vehicle was performed by torque transmitting through a torque converter. The torque converter was mounted to many automatic transmission vehicles since the torque converter has a torque amplifying effect and provides smooth torque transmission.

On the other hand, the torque converter has a disadvantage that a large amount of slip is generated during the torque transmission and, thus, the torque converter has less efficiency.

Therefore, in recent years, there has been proposed a technique in which a starting clutch is used in place of the torque converter, and the torque has been amplified at a low speed range by reducing a gear ratio and by increasing the number of speed change stages.

In general, the starting clutch includes a wet type multi-plate clutch housed in a clutch drum. In the multi-plate clutch, friction plates as friction engaging elements at an output side and separator plates as friction engaging elements at an input side are arranged alternately along an axial direction. With this arrangement, a power is transmitted by engaging the friction plates with the separator plates by means of a piston.

In the starting clutch, since great heat is generated, a large amount of lubricant oil must be flown to achieve the cooling. To this end, a large pump capacity is required. However, oil pumps provided in the conventional transmissions have less pump capacities and, thus, there arises a problem that the starting clutch cannot be mounted as it is. Further, in the conventional oil pumps, since the pump is cooled by a small amount of oil, heat is accumulated in a clutch portion, thereby causing a problem regarding seizure of the clutch.

U.S. Pat. No. 6,929,105 discloses a starting clutch including a plurality of holes capable of sending a large amount of lubricant oil to cool the clutch and of discharging the lubricant oil in a radial direction of a clutch drum. In this case, however, since the lubricant oil is discharged from a clutch portion quickly, heat exchange between the clutch portion and the oil becomes inadequate, with the result that the cooling efficiency for the clutch is worsened and the heat is apt to be accumulated in the clutch portion.

Further, as disclosed in Japanese Patent Application Laid-open No. 2002-054656, in a clutch drum having no radial hole, since oil is not discharged from a clutch portion also in an axial direction, although heat in the clutch is transmitted to the oil, the oil is always accumulated within the clutch. Accordingly, if the clutch is filled with the oil, although the heat in the clutch portion is transmitted to the oil, since the oil is stayed in the clutch portion excessively, with the result that, similar to the U.S. Pat. No. 6,929,105, the heat cannot be removed from the clutch portion smoothly.

### SUMMARY OF THE INVENTION

Accordingly, an object of the present invention is to provide a starting clutch which can cool heat of the clutch efficiently with a small amount of lubricant oil and can enhance heat resistance and endurance of the starting clutch and can achieve an adequate cooling effect even by using an oil pump provided in an existing transmission.

To achieve the above object, the present invention provides a starting clutch apparatus comprising a damper device connected to an output member of an engine, a wet type multi-plate clutch housed in a housing, a piston for pressing the wet type multi-plate clutch to tighten the clutch, and an output member connected to an input shaft of an automatic transmission and wherein an output of the engine is connected to or disconnected from the input shaft of the automatic transmission by engaging or disengaging the wet-type multi-plate clutch, and further wherein the damper device includes a damper output portion engaged by an outer diameter portion of the housing.

By arranging the damper device on the outer diameter portion of the housing, a size of the housing can be reduced. Thus, inertia of the starting clutch apparatus can be reduced, which contributes to quick response of the starting clutch and reduction in fuel consumption, and further, since there is no oil staying or accumulating area in the housing, the wet type multi-plate clutch can be lubricated and cooled efficiently with a small amount of oil.

Further, by arranging the damper device on the outer diameter portion of the housing and by providing an oil chamber for the piston in the housing, an axial attaching space can be shortened, thereby facilitating the attaching of the starting clutch to the existing transmission.

Since the cooling oil is supplied to the clutch plates efficiently, so that the heat is removed from the clutch plates and is discharged from the wet type multi-plate clutch toward the transmission quickly, reduction in the capacity of the oil pump and improvement in heat resistance of the starting clutch apparatus are compatible with each other, thereby reducing the fuel consumption and enhancing the reliability.

The starting clutch apparatus can be cooled with a small amount of lubricant oil and the starting clutch can be attached to the existing transmission. Further, since an oil-path for supplying the lubricant oil is separated from an oil path for returning the lubricant oil toward the transmission by a cover member, smooth oil circulation can be achieved.

Further features of the present invention will become apparent from the following description of exemplary embodiments with reference to the attached drawings.

### BRIEF DESCRIPTION OF THE DRAWINGS

FIGURE is an axial sectional view of a starting clutch apparatus according to an embodiment of the present invention.

### DETAILED DESCRIPTION OF THE INVENTION

Now, an embodiment of the present invention will be fully explained with reference to the accompanying drawing. Incidentally, the embodiment explained hereinbelow is merely an example of the present invention, and it should be noted that other alterations can be made with the scope of the present invention.

FIGURE is an axial sectional view of a starting clutch apparatus according to an embodiment of the present invention. The starting clutch 10 comprises a housing 40 and a wet type multi-plate clutch 30 housed in the housing. The housing 40 includes a clutch drum 1 and a damper support case 11 secured to the clutch drum 1. Within the housing 40, substantially annular friction plates 3 as friction engaging elements at an output side and substantially annular separator plates 4 as friction engaging elements at an input side are arranged alternately along an axial direction.

At an axial one end of the clutch drum 1, a substantially annular backing plate 5 is fixedly supported by a substantially annular stop ring 6 in the axial direction, thereby holding the separator plate 4. The backing plate 5 is provided with a projection 5a extending axially toward the separator plate 4, which projection is adapted to abut against the separator plate 4.

The wet type multi-plate clutch 30 includes a cylindrical member 14 secured to an inner wall of the damper support case 11, which cylindrical member is provided at its inner periphery with a spline portion 15 with which the plurality of separator plates 4 is engaged for an axial sliding movement. As mentioned above, the rightmost separator plate 4 in FIGURE abuts against the backing plate 5.

On the other hand, a hub member 2 disposed within the housing 40 has a cylindrical portion 18 arranged in a confronting relationship to the cylindrical member 14 in a radial direction. The plurality of friction plates 3 is engaged by a spline portion 19 of the cylindrical portion 18 for an axial sliding movement. The friction plates 3 and the separator plates 4 are alternately arranged in the axial direction. The hub member 2 is connected to an output shaft 22 of an automatic transmission (not shown) and serves as an output member of the wet type multi-plate clutch 30.

In the illustrated embodiment, although the wet type multi-plate clutch 30 is constituted by four friction plates 3 and five separator plates 4, it should be noted that the number of the input and output side friction engaging elements can be changed voluntarily in accordance with required torque. Further, substantially annular friction materials 31 are secured to axial both surfaces of the friction plate 3 by an adhesive or the like. In place of the friction material 31, plural friction material segments may be arranged in an annular fashion. Further, the friction materials 31 may be secured to the separator plates 4 or the friction materials 31 may be secured to one of surfaces of the friction plate 3 and the separator plate 4 alternately.

In FIGURE, a piston 8 is provided within an axial inner wall of the damper support case of the housing 40 for an axial sliding movement. Between a hydraulic chamber forming member 16 formed integrally with the piston 8 and the damper support case 11, a hydraulic chamber 21 for applying oil pressure to the piston 8 is defined. Although not shown in FIGURE, a spring may be provided for always biasing the piston 8 toward a clutch releasing direction. The hydraulic chamber 21 is sealed by O-rings 32 and 33.

A projection 8a protruding axially toward the separator plate 4 is provided on an outer end of the piston 8. When oil is supplied to the hydraulic chamber 21 to generate oil pressure, the piston 8 is shifted to the right in FIGURE, so that the projection 8a applies a pressing force to the separator plate 4, with the result that the plural separator plates 4 and the plural friction plates 3 are closely contacted with each other between the piston 8 and the backing plate 5, thereby tightening or engaging the clutch. In this case, it is preferable that the projection 8a of the piston 8 and the projection 5a of the backing plate 5 are coaxially opposed to each other in a condition that they are parallel with the cylindrical portion 18 of the hub member 2 and the cylindrical portion 14 (described later).

By designing so that the projection 8a of the piston 8 presses a center or the vicinity of the center of a load acting area of the separator plate 4, friction surfaces of all of the plates are contacted with each other with uniform face pressure throughout whole engaging surfaces. Further, due to the uniform face pressure, eccentricity of heat generating portions is prevented, thereby enhancing heat-resistance of the clutch portion of the wet type multi-plate clutch 30.

The cylindrical portion 18 of the hub member 2 fitted on the input shaft 22 of the transmission to be integrally rotated with the input shaft 22 is provided with radial through-holes (not shown), so that the lubricant oil from the inner diameter side from the starting clutch 10 is supplied through the through-holes, thereby lubricating the clutch portion.

At a side (rightmost side in FIGURE) of the wet type multi-plate clutch 30 near the backing plate 5, a cover member 17 is provided. An outer edge portion 17a of the cover member 17 is fitted in the spline portion 15 of the cylindrical member 14. Thus, the cover member 17 is rotated integrally with the housing 40. An intermediate portion of the cover member 17 and an intermediate portion of the hub member 2 are closely opposed to each other in the axial direction, thereby defining a narrow passage 44 therebetween.

An outer diameter portion 12 of the damper support case 11 which forms a part of the housing 40 is provided with a damper output receiving portion 43 engaged by a damper output portion 13 of a damper device 50, so that an output from an engine is transmitted to the housing 40. By arranging the damper device 50 on the outer diameter portion of the housing 40, a size of the housing can be reduced in comparison with conventional housings. Thus, inertia of the starting clutch can be reduced, which contributes to quick response of the starting clutch and reduction in fuel consumption, and further, since there is no oil staying or accumulating area in the housing, the wet type multi-plate clutch can be lubricated and cooled efficiently with a small amount of oil.

Further, by arranging the damper device 50 on the outer diameter portion of the housing 40 and by providing the hydraulic chamber 21 for the piston 8 in the housing 40, an axial attaching space can be shortened, thereby facilitating the attaching of the starting clutch to the existing transmission. The damper device 50 is connected to the output side of the engine via a member 41.

Oil from an oil supplying port 26 is passed through a radial through-hole 27 provided in an inner diameter portion of the damper support case 11 and is supplied to high pressure chamber or hydraulic chamber 21 for applying the pressing force to the piston 8.

Now, a path through which the lubricant oil is supplied to the wet type multi-plate clutch 30 will be explained. A cylindrical member 23 is disposed around an outer periphery of the input shaft 22 of the automatic transmission (not shown), so that an oil supplying port or passage 25 extending in the axial direction is formed between the input shaft 22 and the member 23. The lubricant oil supplied from an oil pump (not shown) through the axial passage 25 is passed through a passage 44 defined between the hub member 2 and the cover member 17 to be flown in a direction shown by the arrow A and is supplied to the clutch portion via a through hole of the cylindrical portion 19 of the hub member 2.

The lubricant oil which lubricated the clutch portion enters into a space defined between the clutch case 1 and the cover member 17 through a clearance between splines of the spline portion 15 of the cylindrical member 14 or clearances between the friction plates 3 and the separator plates 4 and is discharged in a direction shown by the arrow B.

The lubricant oil discharged from the space between the clutch case 1 and the cover member 17 passes through a passage 24 defined between an inner diameter portion 20 of the clutch case 1 and the input shaft 22 and is discharged toward the transmission.

As mentioned above, since the flow of the lubricant oil shown by the arrow A is separated from the flow of the lubricant oil shown by the arrow B which lubricated the clutch portion and which is returned toward the transmission by the cover member 17, smooth circulation of the lubricant oil can be achieved.

With the arrangement as mentioned above, the starting clutch can be cooled with a smaller amount of lubricant oil and the starting clutch can be attached to the existing transmission.

In the embodiment as mentioned above, the oil pressure applied to the piston 8 for generating the pressing force to engage or tighten the wet type multi-plate clutch 30 of the starting clutch apparatus 10 can be set in consideration of factors such as a weight of a vehicle, coefficients of friction of the friction engaging elements of the starting clutch, surface areas of the friction engaging surfaces and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-217935, filed on Aug. 24, 2007, which is hereby incorporated by reference in its entirety.

What is claimed is:

1. A starting clutch apparatus comprising:
a damper device connected to an output member of an engine;
a wet type multi-plate clutch housed in a housing;
a piston for pressing said wet type multi-plate clutch to tighten said clutch; and
an output member connected to an input shaft of an automatic transmission;
and wherein
an output of said engine is connected to or disengaged from said input shaft of said automatic transmission by engaging or disengaging said wet type multi-plate clutch;
and further wherein
said damper device includes a damper output portion engaged by an outer diameter portion of said housing.

2. A starting clutch apparatus according to claim 1, wherein said damper output portion is spline-fitted in said outer diameter portion of said housing.

3. A starting clutch apparatus according to claim 1, wherein a cover member extending toward an inner diameter side is provided at an end surface of an open end of said housing into which said wet type multi-plate clutch is fitted.

4. A starting clutch apparatus according to claim 3, wherein lubricant oil for said wet type multi-plate clutch is supplied from a space between said output member of said wet type multi-plate clutch and said cover member.

5. A starting clutch apparatus according to claim 4, wherein the lubricant oil which lubricated said wet type multi-plate clutch is returned toward said transmission through a space between said cover member and said housing.
